(19) United States
(12) Patent Application Publication
(10) Pub. No.: US 2017/0149772 A1
(43) Pub. Date: May 25, 2017

(54) IDENTITY AUTHENTICATION METHOD, SYSTEM, BUSINESS SERVER AND AUTHENTICATION SERVER

(71) Applicant: Alibaba Group Holding LImited, Goerge Town (KY)

(72) Inventors: Xiaofeng WANG, Hangzhou (CN); Weiqin WAN, Hangzhou (CN); Yang YU, Hangzhou (CN)

(21) Appl. No.: 15/353,020

(22) Filed: Nov. 16, 2016

(30) Foreign Application Priority Data
Nov. 24, 2015 (CN) 201510825231.0

(51) Int. Cl. H04L 29/06; G06F 21/31

(52) U.S. Cl. CPC H04L 63/0853; H04L 63/083; H04L 63/0884; G06F 21/313; H04L 63/18; H04L 2209/76

(57) ABSTRACT

Embodiments of the present application provide an identity authentication method, business server, authentication server and identity authentication system. According to some embodiments, the method includes acquiring a first user identification code corresponding to a client when a data interaction request sent by the client is received, sending the first user identification code to the authentication server, acquiring an intermediate number corresponding to the first user identification code from the authentication server, sending the intermediate number to the client for a client-side user to initiate a call request to the intermediate number using a telephone communication network, receiving an authentication result of the identity authentication from the authentication server according to the call request, and processing the data interaction request according to the authentication result. The identity authentication method of embodiments of the present application improves the reliability and security of identity authentication.

### CROSS-REFERENCE TO RELATED APPLICATION

This application claims priority to Chinese Patent Application No. 201510825231.0, filed on Nov. 24, 2015, which is incorporated herein by reference in its entirety.

### TECHNICAL FIELD

Embodiments of the present application relate to interconnection network technology, and particularly to an identity authentication method, system, business server and authentication server.

### BACKGROUND

With the ongoing development of interconnection network technology, more and more users may interact with each other or acquire services using interconnection networks. In many cases, where users perform interconnection network or mobile interconnection network activities, such as registration and login tasks, user identity authentication is necessary to identify that a legal operation has been initiated by the user themselves. Currently, an authentication code is sent to a user terminal using a voice or text message, and the user enters the authentication code in a corresponding location in response to a prompt. Next, the authentication code may be transferred to a backend server through the interconnection network or the mobile interconnection network. Then, the backend server verifies consistency between the authentication code entered by the user and the authentication code that has been issued to the user. The authentication is verified if the result is consistent. However, such a method results in lower security because the authentication code is prone to being intercepted by a third party or a virus/malware during transmission or when arriving to the cell phone, and the safe and timely arrival of the text message cannot be guaranteed. An authentication code spoken verbally is prone to be mistaken, so the success rate of verbal identity authentication is below an acceptable value, and the user experience suffers.

### SUMMARY

Embodiments of the present application provide an identity authentication method, business server, authentication server and identity authentication system. The identity authentication method of embodiments of the present application improves the reliability and security of identity authentication. According to one embodiment, a method of performing identify authentication is disclosed and includes acquiring a first user identification code corresponding to a client when a data interaction request sent by the client is received, sending the first user identification code to the authentication server, acquiring an intermediate number corresponding to the first user identification code from the authentication server, sending the intermediate number to the client to initiate a call request to the intermediate number using a telephone communication network, receiving an authentication result of the identity authentication from the authentication server according to the call request, and processing the data interaction request according to the authentication result.

According to another embodiment, an authentication server is disclosed. The authentication server includes a receiving module for receiving a first user identification code sent by a business server, an allocation module for allocating an intermediate number corresponding to the first user identification code, a returning module for returning the intermediate number to the business server to provide the intermediate number to a client, an acquisition module for acquiring a second user identification code, where a call is initiated to the intermediate number using a telephone communication network and the second user identification code, and an authentication module for verifying consistency between the first user identification code and the second user identification code to generate an authentication result, and for sending the authentication result to the business server.

Additional aspects and advantages of the present application will be partially given in the following description, portions of which will become apparent from the following description, or understood through practice of the present application.

### BRIEF DESCRIPTION OF DRAWINGS

The above and/or additional aspects and advantages of the present application will become apparent and easy to understand from the description of the embodiments in conjunction with attached drawings below, in which:

FIG. 1 is a flow diagram showing an exemplary identity authentication method according to embodiments of the present application;

FIG. 2 is a flow diagram showing an exemplary identity authentication method according to embodiments of the present application;

FIG. 3 is a flow diagram showing an exemplary identity authentication method according to embodiments of the present application;

FIG. 4 is a schematic diagram showing an exemplary synchronous location update of an authentication server according to embodiments of the present application;

FIG. 5 is a schematic diagram showing an exemplary business server according to embodiments of the present application;

FIG. 6 is a schematic diagram showing an exemplary business server according to embodiments of the present application;

FIG. 7 is a schematic diagram showing an exemplary business server according to embodiments of the present application;

FIG. 8 is a schematic diagram showing an exemplary authentication server according to embodiments of the present application;

FIG. 9 is a schematic diagram showing an exemplary identity authentication system according to embodiments of the present application.

### DETAILED DESCRIPTION

Embodiments of the present application are described in detail below. Examples of the embodiments are shown in attached drawings, in which the same or similar numerals indicate the same or similar elements, or elements with the same or similar functions from beginning to end. The embodiments described below with reference to the attached drawings are exemplary, are used only for explanation of the present application, and cannot be understood as limitation to the present application.

Many networks, such as the internet, interconnection networks, or mobile interconnection networks, are open networks, and have a very low access threshold and relatively low security. There is security risk when an authentication code is transferred through the internet during an identity authentication process. Therefore, an identity authentication method, a business server, an authentication server and an identity authentication system are proposed in embodiments of the present application in order to solve the problems mentioned above.

The identity authentication method, the business server, the authentication server and the identity authentication system according to the embodiments of the present application are described below with reference to the attached drawings.

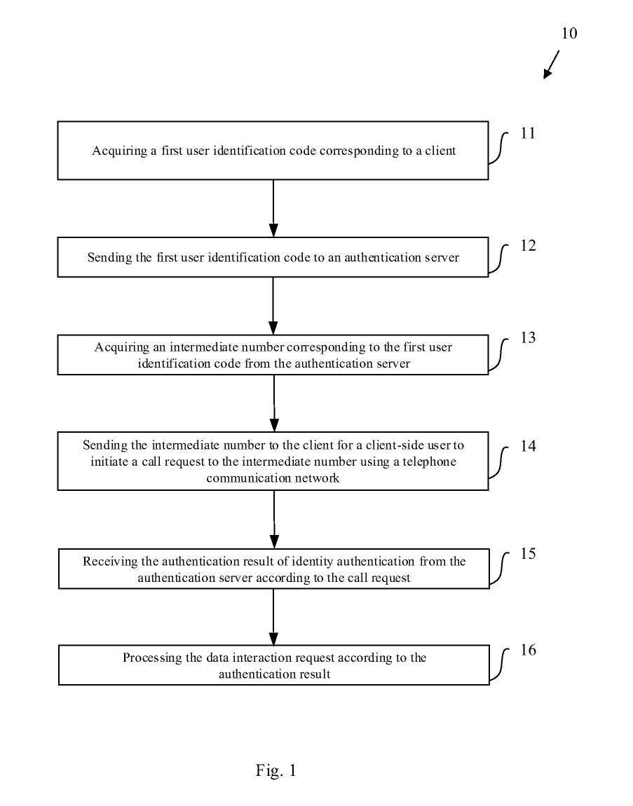

FIG. 1 is a flow diagram showing an exemplary identity authentication method according to embodiments of the present application.

As shown in FIG. 1, the identity authentication method 10 includes:

In step 11, a first user identification code corresponding to a client is acquired when a data interaction request sent by the client is received through an internet.

The internet may include an interconnection network or a mobile interconnection network, for example, or any IP network based on an IP (Internet Protocol) protocol.

A data interaction request may be sent by means of an HTTP (Hyper Text Transfer Protocol) request. The data interaction request may be a registration request, a login request, a user information change request, a payment request, a transfer request, a query request, etc.

The first user identification code corresponding to the client includes identity identification information of the client-side user in the telephone communication network for uniquely identifying a client-side user in the telephone communication network. For example, the first user identification code may be a phone number, a MSIN (Mobile Subscriber Identification Number), an IMSI (International Mobile Subscriber Identification Number), etc.

According to some embodiments, the telephone communication network is a closed network composed of signaling networks and traffic networks.

Specifically, a client may send a data interaction request to the business server in response to an operation of the user. The business server may acquire the first user identification code of the client-side user after receiving the data interaction request sent by the client.

For example, as the user initiates a payment request through the client, the client may send the payment request to the business server, and the business server then initiates a subsequent authentication process.

According to some embodiments of the present application, a business server may send a user identification code input request to the client for the client-side user to input the first user identification code. Specifically, the business server may send the user identification code input request to the client after receiving the data interaction request. After the user identification code input request is received by the client, the client may provide a user identification code input interface, prompt the user to input the code, and return the user identification code inputted by the user to the business server.

According to some embodiments of the present application, the business server extracts the first user identification code of the client-side user from a user database. The business server may store the user identification code corresponding to user account information in advance, and may look up a corresponding user identification code in the user data according to the account information corresponding to the received data interaction request after receiving the data interaction request. For example, when the user registers, or submits a phone number after registration, the business server may store the association between the account of the user and the phone number. When the data interaction request is received from the account of the user, the corresponding phone number may be extracted using the account.

In step 12, the first user identification code is sent to the authentication server.

The authentication server is used to perform identity authentication for the user, and the business server is used to provide a corresponding business service for the client. The business server may communicate with the authentication server over the internet, for example.

In step 13, an intermediate number corresponding to the first user identification code is acquired from the authentication server.

The authentication server may allocate and return a corresponding intermediate number for the first user identification code to the authentication server when receiving the first user identification code sent by the business server. The intermediate number may be a phone number, a special service number, a fixed telephone number or a VoIP (Voice over Internet Protocol) number, for example.

According to some embodiments of the present application, the intermediate number may be a fixed number or a temporary number. Specifically, the authentication server may use a preset number as the intermediate number corresponding to the first user identification code. In addition, the authentication server may also randomly select one temporary number from a preset number pool, and use the temporary number as the intermediate number corresponding to the first user identification code. The preset number pool may be created at the business server in advance.

In step 14, the intermediate number is sent to the client for a client-side user to initiate a call request to the intermediate number through a telephone communication network.

After the business server acquires the intermediate number corresponding to the first user identification code from the authentication server, the intermediate number may be sent to the client. The client may display the intermediate number, and the client-side user may initiate the call request to the intermediate number using the telephone communication network.

Equipment used by the user for initiating a call may be client-side equipment, and there may be other call equipment available to the user. For example, if the client-side equipment is a phone, then the client may render a call interface corresponding to the intermediate number on the phone, such that the user may initiate a call to the intermediate number directly using numeric dial keys. If the client-side equipment is a computer, then the user may use a phone to initiate a call to the intermediate number displayed at the client.

In step 15, an authentication result of the identity authentication from the authentication server is received in response to the call request.

The authentication server may acquire a second user identification code, and initiate a call to the intermediate number using the second user identification code, from the telephone communication network, and verify consistency between the first user identification code and the second user identification code, followed by returning an authentication result to the business server.

In step 16, the data interaction request is processed according to the authentication result.

If the authentication result returned by the authentication server shows consistency between the first user identification code and the second user identification code, then the authentication for the client-side user is determined to be verified (this call is initiated by the user themselves), and a response to the data interaction request is issued. If the authentication result returned by the authentication server shows inconsistency between the first user identification code and the second user identification code, then the authentication for the client-side user is determined to have failed, and the response to the data interaction request is rejected. In this case, the client-side user is prompted with a failure notification.

When the data interaction request of the client is received, the first user identification code corresponding to the client may be acquired, and the intermediate number corresponding to the first user identification code may be acquired from the authentication server and sent to the client for display, allowing the client-side user to initiate a call to the intermediate number through the telephone communication network, and allowing the authentication server to obtain an authentication result according to the call request. In this way, the closed nature of a telephone communication network, and the open nature of the internet are brought together to increase security and improve performance. Furthermore, the telephone communication network has a higher access threshold in comparison to the internet due to the closed nature of the telephone communication network, making it difficult to be accessed externally. Therefore, the reliability and the security of the identity authentication are improved effectively by using the high security telephone communication network for identity authentication on the traditional internet, and by changing the identity authentication process from an asynchronous flow to a synchronous flow.

Moreover, by performing authentication over a telephone call, conversation and authentication may be accomplished synchronously to increase authentication efficiency and improve authentication experience of the user.

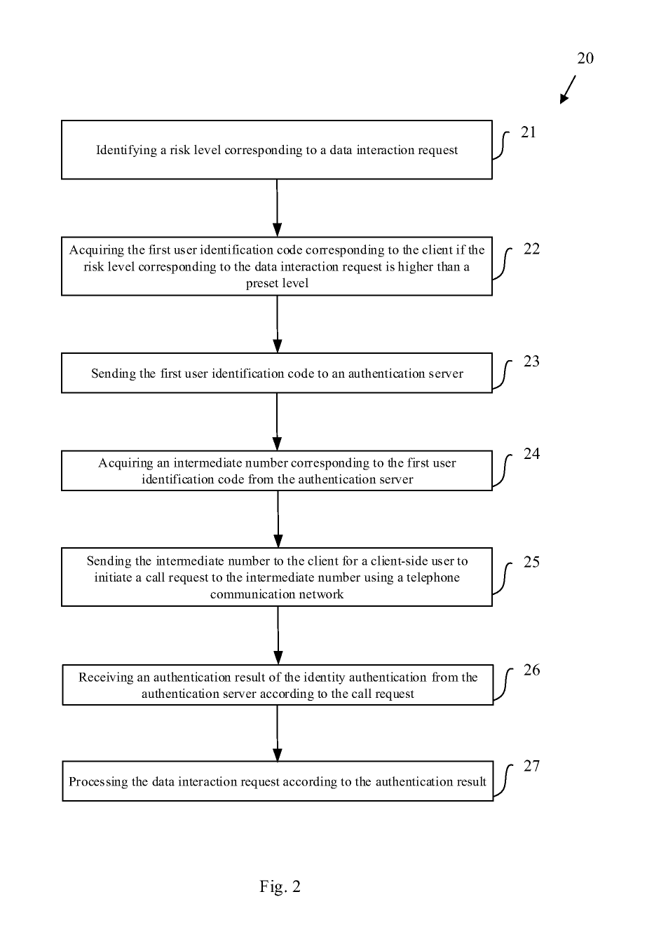

FIG. 2 is a flow diagram showing an exemplary identity authentication method according to embodiments of the present application.

As shown in FIG. 2, the identity authentication method 20 includes:

In step 21, a risk level of a data interaction request is identified when the data interaction request sent by the client is received over the internet.

According to some embodiments of the present application, the business server may identify the corresponding risk level according to a request type of the data interaction request. The risk levels corresponding to different request types may be system default values, or may be preset by the user according to requirements. For example, the risk level may be high if the data interaction request is a large payment request; the risk level may be low if the data interaction request is a query request; and the risk level may be intermediate if the data interaction request is a user information modification request (e.g., a request to modify a user's profile information).

In step 22, the first user identification code corresponding to the client is acquired if the risk level corresponding to the data interaction request is higher than a preset level.

The preset level may be a default setting, or may be defined by the user. For example the preset level may be an intermediate level.

Accordingly, the business server will acquire the first user identification code corresponding to the client, and initiate a subsequent authentication flow, only when the risk level corresponding to the data interaction request is higher than the preset level.

In step 23, the first user identification code is sent to the authentication server.

In step 24, an intermediate number corresponding to the first user identification code is acquired from the authentication server.

In step 25, the intermediate number is sent to the client for a client-side user to initiate a call request to the intermediate number using a telephone communication network.

In step 26, an authentication result of identity authentication is received from the authentication server in response to the call request.

In step 27, the data interaction request is processed according to the authentication result.

Steps 23 to 27 are substantially the same as steps 12 to 16 of the embodiment shown in FIG. 1, and are included herein by reference to the embodiment shown in FIG. 1.

According to some embodiments of the present application, when the identity of the client-side user is authenticated, the authentication result returned by the authentication server is considered, and further, an interactive operation of the user during the call process may be considered when performing authentication.

Some embodiments of the present application further include: receiving an interaction record sent by the authentication server during the call process, and performing identity authentication for the client-side user according to the interaction record. The authentication server may record and return the interaction record of the user during the call process to the business server, and the business server may determine if the interaction record meets a preset interaction requirement. If the interaction record meets the preset interaction requirement, and the authentication server determines that there is consistency between the first user identification code and the second user identification code, then the identity authentication of the user is determined to be verified. Otherwise, if a condition is not met, then the identity authentication of the user is determined to have failed.

Interaction scenarios for the user in the call process may be set using different security authentication levels.

Exemplary Scenario 1

Low level authentication: The authentication server plays a preset prompt tone after a call initiated to the intermediate number is answered, and the conversation ends after the playback is complete. In this process, the client-side user does not need to perform an operation. After the conversation is completed, the business server indicates that the interaction record meets the preset interaction requirement.

Exemplary Scenario 2

Intermediate level authentication: After the call initiated to the intermediate number is answered, the authentication server plays verbal instructions prompting the user to press a corresponding key, and records the key press operation of the user. If the key press operation of the user is consistent with the voice prompt, the business server indicates that the interaction record meets the preset interaction requirement.

Exemplary Scenario 3

High level authentication: After the call initiated to the intermediate number is answered, the authentication server prompts the user with verbal instructions to enter a corresponding string of characters, and records the string entered by the user. If the string entered by the user is consistent with the string in the voice prompt, then the business server indicates that the interaction record meets the preset interaction requirement.

Settings corresponding to the identity of the user, security environment of the client etc., may be requested based on the identity authentication for the specific security authentication level. For example, for a user with a normal status, when the client is in a secure service environment, the low level authentication is selected; if the user has an abnormal status (such as being logged in a different location), intermediate level authentication is selected; if the user is flagged or reported, or the client is in an insecure service environment (such as an environment that is susceptible to malicious attack by a virus or trojan), high level authentication is selected.

The determination of whether the interaction record meets the preset interaction requirement may also be determined by the authentication server. After which, the authentication server determines whether the identity authentication of the user is verified according to the determination result and the authentication result for the first user identification code and the second user identification code, and returns the determination result to the business server.

When the data interaction request of the customer is received, a determination is made whether to initiate the authentication process or not based on the risk level corresponding to the data interaction request. Situations that do not rely on identity authentication can be filtered out to effectively increase the response speed of the data interaction request.

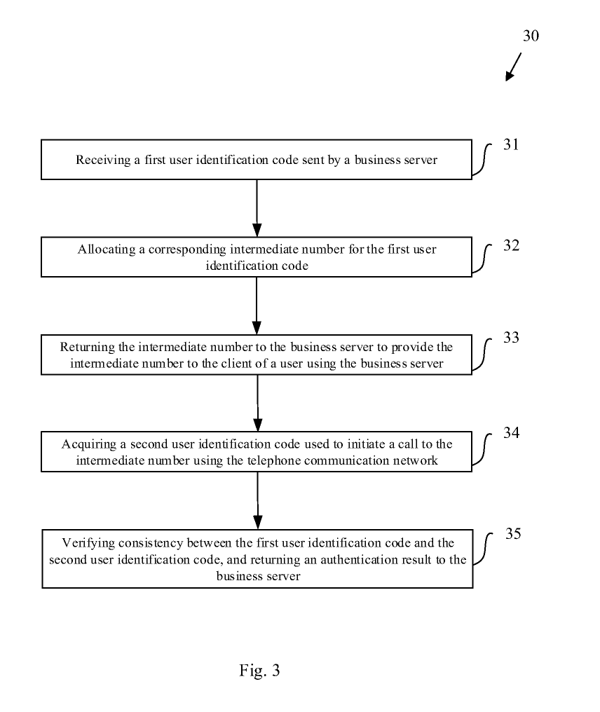

FIG. 3 is a flow diagram showing an exemplary identity authentication method according to embodiments of the present application.

As shown in FIG. 3, the exemplary identity authentication method 30 includes:

In step 31, a first user identification code sent by a business server is received.

The authentication server may receive the first user identification code sent by the business server through the internet. The first user identification code may include identity identification information of the client-side user for uniquely identifying the client-side user in the telephone communication network. For example, the first user identification code may be a phone number, a MSIN (Mobile Subscriber Identification Number), an IMSI (International Mobile Sub scriber Identification Number), etc.

The authentication server is used to process identity authentication for the user, while the business server used to provide a corresponding business services for the client. The business server may communicate with the authentication server over the internet.

The internet may be an interconnection network or a mobile interconnection network, for example, an IP network based on an IP (Internet Protocol) protocol. The telephone communication network is a closed network comprising signaling networks and/or traffic networks.

Specifically, a client may send a corresponding data interaction request to the business server through an operation of the user. The business server may acquire the first user identification code of the client-side user after receiving the data interaction request sent by the client. For example, when the user initiates a payment request using the client, the client may send the payment request to the business server, which then initiates a subsequent authentication process.

The data interaction request may be a registration request, a login request, a user information change request, a payment request, a transfer request, a query request, etc. The data interaction request may be sent by means of an HTTP (Hyper Text Transfer Protocol) request.

The business server may send a user identification code input request to the client for the client-side user to input the first user identification code. Alternatively, the business server may extract the first user identification code of the client-side user from a user database.

In step 32, a corresponding intermediate number is allocated for the first user identification code.

The intermediate number may be a phone number, a special service number, a fixed telephone number or an VoIP (Voice over Internet Protocol) number, etc.

The intermediate number may be a fixed number or a temporary number.

In some embodiments of the present application, the authentication server may use a preset number as the intermediate number corresponding to the first user identification code.

If a fixed number is used as the intermediate number, then the routing for the fixed number in the telephone communication network is directed to the authentication server such that the call to the fixed number can reach the authentication server.

In another embodiment of the present application, the authentication server may randomly select one temporary number from a preset number pool, and use the temporary number as the intermediate number corresponding to the first user identification code. The preset number pool may be established by the business server in advance.

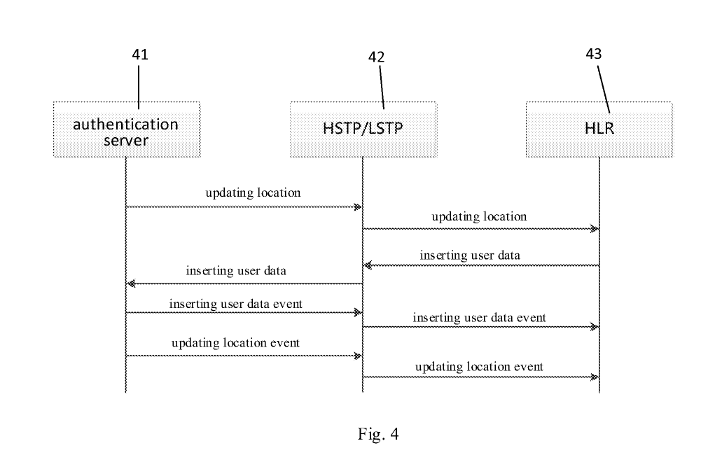

If a temporary number is used as the intermediate number, the authentication server performs a synchronous location update after selecting the temporary number. As shown in FIG. 4, Home Location Register (HLR) 43 in the telephone communication network is notified that the routing for the selected temporary number is directed to the authentication server 41, and the call to the temporary number can reach the authentication server 41. The authentication server communicates with HLR 43 through High/Low Signal Transfer Point (HSTP/LSTP) 42, which is a signaling transfer point in traditional communication networks.

In step 33, the intermediate number is returned to the business server for providing the intermediate number to the client.

After the business server acquires the intermediate number corresponding to the first user identification code from the authentication server, the intermediate number may be sent to the client. The client displays the intermediate number to the user, so that the client-side user may initiate a call request to the intermediate number using the telephone communication network.

In step 34, a second user identification code is acquired from the telephone communication network used to call the intermediate number.

Since the intermediate number is directed to the authentication server, when the intermediate number is called, the authentication server may receive the call request, and a number used to initiate a call to the intermediate number (e.g., the second user identification code) may be acquired from the telephone communication network.

In step 35, consistency between the first user identification code and the second user identification code is verified, and an authentication result is returned to the business server.

If the authentication result of the authentication server shows consistency between the first user identification code and the second user identification code, then the authentication for the client-side user is determined to be verified, and the business server may respond to the data interaction request. If the authentication result of the authentication server shows inconsistency between the first user identification code and the second user identification code, then the authentication for the client-side user may be determined to have failed, and the business server may send a rejection or decline to respond to the data interaction request, and/or prompt the client-side user that the authentication has failed.

According to some embodiments of the present application, the authentication server may record the interaction record of the user during the call process, and determine whether the interaction record meets the preset interaction requirement. If the interaction record meets the preset interaction requirement, and the authentication server finds consistency between the first user identification code and the second user identification code, then the identity authentication of the user is determined to be verified. Otherwise, if a condition is not met, then the identity authentication of the user is determined to have failed. The authentication result is then sent to the business server.

The authentication server may also send the interaction record of the user to the business server during the call process. Next, the business server determines whether the identity authentication is verified based on the result of the comparison between the user identification codes and the determination result of the interaction record.

When performing an identity authentication method, according to some embodiments of the present application, a corresponding intermediate number may be allocated for the first user identification code sent by the business server, and may be provided to the client of the user through the business server. When the intermediate number receives the call, a second user identification code for initiating a call to the intermediate number is acquired from the telephone communication network, and the authentication result is obtained after verifying the consistency between the first user identification code and the second user identification code. In this way, the closed nature of a telephone communication network and the open nature of the internet are brought together to increase security and improve the performance of identity authentication. Furthermore, the telephone communication network has a higher access threshold in comparison to the internet due to the closed nature of the telephone communication network, making it difficult for the network to be accessed externally. Therefore, the reliability and the security of the identity authentication are improved effectively by using the high security telephone communication network for identity authentication on the internet, and by changing the identity authentication process from an asynchronous flow to a synchronous flow.

In the present application, it should be understood that the business server and the authentication server may be the same server according to some embodiments, and they may be separate servers, according to other embodiments.

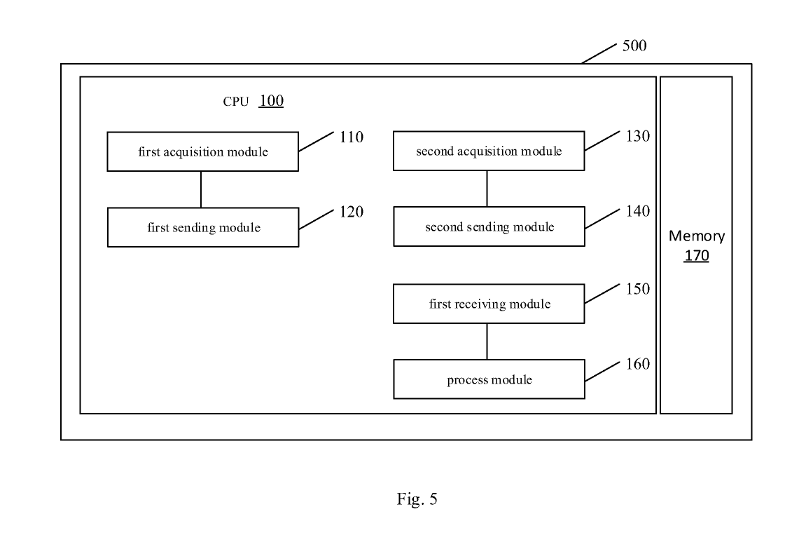

FIG. 5 is a schematic diagram showing a structure of an exemplary business server according to embodiments of the present application.

As shown in FIG. 5, the business server 500 includes: a first acquisition module 110, a first sending module 120, a second acquisition module 130, a second sending module 140, a first receiving module 150 and a process module 160.

Specifically, the first acquisition module 110 is used to acquire a first user identification code associated with a client when a data interaction request sent by the client is received over the internet.

The client may send a corresponding data interaction request to the business server in response to an operation of the user. The first acquisition module 110 may acquire the first user identification code of the client-side user after receiving the data interaction request sent by the client.

For example, when the user initiates a payment request using the client, the client may send the payment request to the business server, which then initiates a subsequent authentication process.

According to some embodiments of the present application, the first acquisition module 110 may be used to send a user identification code input request to the client for the client-side user to input the first user identification code. Specifically, the first acquisition module 110 may send the user identification code input request to the client after receiving the data interaction request. After the user identification code input request is received by the client, the client may provide a user identification code input interface, prompt the user to input the code, and return the user identification code inputted by the user to the business server.

In another embodiment of the present application, the first acquisition module 110 may be used to extract the first user identification code of the client-side user from a user database. The business server may store the user identification code corresponding to user account information in advance, and the first acquisition module 110 may look up a corresponding user identification code in the user data according to the account information corresponding to the data interaction request. For example, when the user registers or submits a phone number after registration, the business server may preserve correspondence between the account of the user and the phone number. When the data interaction request is received from the account of the user, the corresponding phone number may be extracted and associated with the account.

The sending module 120 is used to send the first user identification code to the authentication server.

The second acquisition module 130 is used to acquire an intermediate number corresponding to the first user identification code from the authentication server.

According to some embodiments of the present application, the authentication server may allocate and return a corresponding intermediate number for the first user identification code to the authentication server upon receiving the first user identification code sent by the business server. The intermediate number may be a phone number, a special service number, a fixed telephone number or a VoIP (Voice over Internet Protocol) number etc.

The intermediate number may be a fixed number or a temporary number. Specifically, the authentication server may use a preset number as the intermediate number corresponding to the first user identification code. In addition, the authentication server may randomly select one temporary number from a preset number pool, and use the temporary number as the intermediate number corresponding to the first user identification code. The preset number pool may be established by the business server in advance.

The second sending module 140 is used to send the intermediate number to the client for a client-side user to initiate a call request to the intermediate number using a telephone communication network.

After the second acquisition module 130 acquires the intermediate number corresponding to the first user identification code from the authentication server, the second sending module 140 may send the intermediate number to the client. The client may display the intermediate number, and the client-side user may initiate the call request to the intermediate number through the telephone communication network.

Equipment used by the user for initiating a call may be client-side equipment, such as a phone or other communication equipment. For example, if the client-side equipment is a phone, the client may render a call interface corresponding to the intermediate number in the phone, such that the user may initiate a call to the intermediate number directly by pressing or activating a dial keys. If the client-side equipment is a computer, then the user may use a phone to initiate a call to the intermediate number displayed at the client.

The first receiving module 150 is used to receive an authentication result of the identity authentication sent by the authentication server in response to the call request.

According to some embodiments of the present application, the authentication server may acquire a second user identification code for initiating a call to the intermediate number, using the telephone communication network, and for verifying consistency between the first user identification code and the second user identification code, followed by returning an authentication result to the business server.

The process module 160 is used to process the data interaction request according to the authentication result.

If the authentication result returned by the authentication server shows consistency between the first user identification code and the second user identification code, then the authentication for the client-side user is determined to be verified, so that the process module 160 may respond to the data interaction request; if the authentication result returned by the authentication server shows inconsistency between the first user identification code and the second user identification code, then the authentication for the client-side user is determined to have failed, and the process module 160 may reject the data interaction request, and notify the client-side user of the failed authentication.

When the data interaction request of the client is received by the business server, the first user identification code corresponding to the client is acquired, and the intermediate number corresponding to the first user identification code is acquired from the authentication server and sent to the client for display. The client-side user to initiate a call to the intermediate number through the telephone communication network, and the authentication server obtains an authentication result based on the call request. In this way, the closed nature of a telephone communication network, and the open nature of the internet are brought together to increase security and improve performance. Furthermore, the telephone communication network has a higher access threshold in comparison to the internet due to the closed nature of the telephone communication network, making it difficult to be accessed externally. Therefore, the reliability and the security of the identity authentication are improved by applying the high security of the telephone communication network to identity authentication for the traditional internet, and by changing the identity authentication process from an asynchronous flow to a synchronous flow.

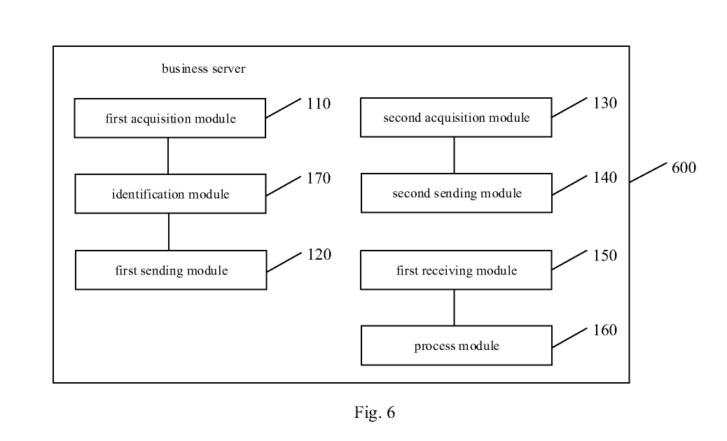

FIG. 6 is a schematic diagram showing an exemplary business server according to embodiments of the present application.

As shown in FIG. 6, the business server 600 includes a processor 100 and a memory 170 communicatively coupled to the processor 100. Processor 100 may include a first acquisition module 110, a first sending module 120, a second acquisition module 130, a second sending module 140, a first receiving module 150, a process module 160 and an identification module 170, or alternatively, the modules may be implemented as separate components (e.g., dedicated hardware components) of business server 600. Memory 170 is used to store data for processing by processor 100.

Specifically, the first acquisition module 110, the first sending module 120, the second acquisition module 130, the second sending module 140, the first receiving module 150 and the process module 160 are generally the same components described with regard to the embodiment shown in FIG. 5.

The identification module 170 is used for identifying a risk level corresponding to a data interaction request when the data interaction request sent by the client is received over the internet.

The identification module 170 identifies the corresponding risk level based on a request type of the data interaction request. The risk levels corresponding to different request types may be system default values, or may be preset by the user. For example, the risk level may be high if the data interaction request is a large payment request, the risk level may be low if the data interaction request is a query request, and the risk level may be intermediate if the data interaction request is a user information modification request (e.g., a request to modify a user's account or profile information).

The first acquisition module 110 is used to acquire a first user identification code of a user at a client when the risk level corresponding to the data interaction request is higher than a preset level.

The preset level may be a default setting, or may be set by the user. For example the preset level may be set to an intermediate level.

Accordingly, when the risk level corresponding to the data interaction request is higher than the preset level, the first acquisition module 110 will acquire the first user identification code corresponding to the client, and initiate a subsequent authentication flow.

When the data interaction request of the customer is received at the business server, the decision to initiate the authentication process may be based on the risk level corresponding to the data interaction request, such that situations that do not call for identity authentication can be filtered out to increase the speed at which data interaction requests are processed.

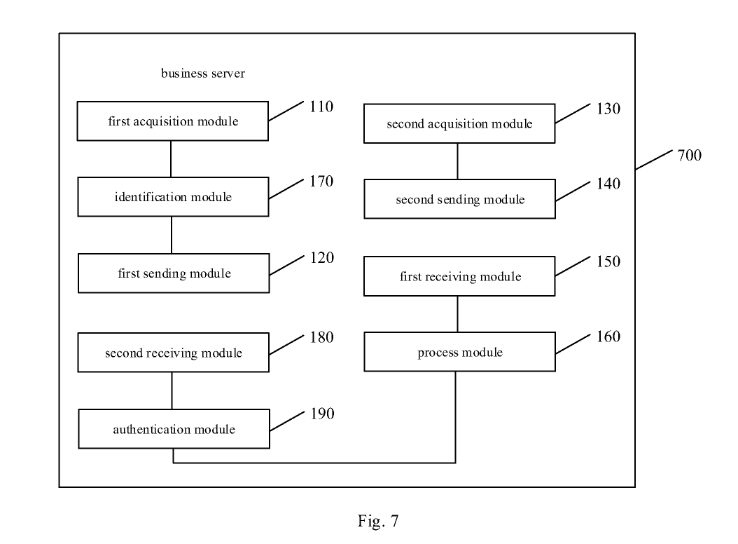

FIG. 7 is a schematic diagram showing an exemplary business server according to embodiments of the present application.

As shown in FIG. 7, the business server 700 includes: a first acquisition module 110, a first sending module 120, a second acquisition module 130, a second sending module 140, a first receiving module 150, a process module 160, an identification module 170, a second receiving module 180 and an authentication module 190.

Specifically, the first acquisition module 110, the first sending module 120, the second acquisition module 130, the second sending module 140, the first receiving module 150, the process module 160 and the identification module 170 are generally the same components described with regard to the embodiment shown in FIG. 6.

The second receiving module 180 is used for receiving an interaction record sent by the authentication server in a call process.

The authentication server may record and return the interaction record of a user during a call process to the business server.

The authentication module 190 may be used for performing identity authentication for the client-side user based on the interaction record.

Specifically, the authentication module 190 may determine if the interaction record meets a preset interaction requirement. If the interaction record meets the preset interaction requirement, and the authentication result from the authentication server indicates consistency between the first user identification code and the second user identification code, then the identity authentication of the user is determined to be verified. Otherwise, if a condition is not met, then the identity authentication of the user is determined to have failed.

Interaction scenarios for the user in the call process may be set according to different security authentication levels.

Exemplary Scenario 1

Low level authentication: The authentication server plays a preset prompt tone after a call initiated to the intermediate number is answered, and the conversation ends after the playback is complete. In this process, the client-side user does not need to perform an operation. After the conversation is completed, the business server indicates that the interaction record meets the preset interaction requirement.

Exemplary Scenario 2

Intermediate level authentication: After the call initiated to the intermediate number is answered, the authentication server plays verbal instructions which prompt the user to press a corresponding key, and records the key press operation of the user. If the key press operation of the user is consistent with the voice prompt, the business server indicates that the interaction record meets the preset interaction requirement.

Exemplary Scenario 3

High level authentication: After the call initiated to the intermediate number is answered, the authentication server prompts the user with verbal instructions to enter a corresponding string, and records the string entered by the user. If the string entered by the user is consistent with the string played in the voice prompt, then the business server indicates that the interaction record meets the preset interaction requirement.

Settings related to the identity of the user, the security environment of the client, etc., may be requested according to the identity authentication for the security authentication level.

For example, if the user has a normal status and the client is in a secure service environment, then the low level authentication is selected, if the user is in an abnormal status (such as being logged in at a different location), then the intermediate level authentication is selected, and if the user is reported, or the client is in an insecure service environment (such as an environment susceptible to malicious attacks by a virus or trojan), then the high level authentication is selected.

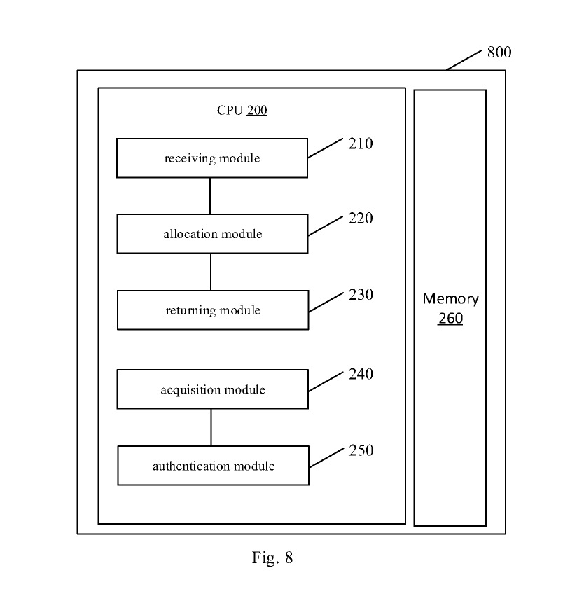

FIG. 8 is a schematic diagram showing an exemplary authentication server according to embodiments of the present application.

As shown in FIG. 8, authentication server 800 includes a processor 200 and a memory 260 communicatively coupled to the processor 200. Processor 200 may include: a receiving module 210, an allocation module 220, a returning module 230, an acquisition module 240 and an authentication module 250, or alternatively, the modules may be implemented as separate components (e.g., dedicated hardware components) of authentication server 800. Memory 260 is used to store data for processing by processor 200.

Specifically, the receiving module 210 is used for receiving a first user identification code sent by a business server.

The receiving module 210 may receive the first user identification code sent by the business server through the internet.

The client may send a corresponding data interaction request to the business server in response to an operation of a user. The business server may acquire the first user identification code of the client-side user after receiving the data interaction request sent by the client. For example, when the user initiates a payment request through the client, the client may send the payment request to the business server, which then initiates a subsequent authentication process.

The allocation module 220 is used to allocate a corresponding intermediate number for the first user identification code.

The intermediate number may be a phone number, a special service number, a fixed telephone number or an VoIP (Voice over Internet Protocol) number etc.

According to some embodiments of the present application, the intermediate number may be a fixed number or a temporary number.

According to some embodiments of the present application, the allocation module 220 may be used to set a preset number as the intermediate number corresponding to the first user identification code.

If a fixed number is used as the intermediate number, then the routing for the fixed number in the telephone communication network is directed to the authentication server such that the call to the fixed number can reach the authentication server.

According to some embodiments of the present application, the allocation module 220 may also be used to randomly select a temporary number from a preset number pool, and use the temporary number as the intermediate number corresponding to the first user identification code. The preset number pool may be established by the business server in advance.

If a temporary number is used as the intermediate number, then the authentication server has to perform synchronous location update after selecting the temporary number. As shown in FIG. 4, the Home Location Register (HLR) 43 in the telephone communication network is notified that the routing for the selected temporary number is directed to the authentication server 41 so the call to the temporary number can reach the authentication server 41. The authentication server 41 communicates with HLR 43 through HSTP/LSTP 42.

The returning module 230 is used for returning the intermediate number to the business server so that the intermediate number can be provided to the client.

After the business server acquires the intermediate number corresponding to the first user identification code from the authentication server, the intermediate number may be sent to the client of the user. The client displays the intermediate number to the user, so that the client-side user may initiate a call request to the intermediate number over the telephone communication network.

The acquisition module 240 is used to acquire a second user identification code used to initiate a call to the intermediate number, from the telephone communication network.

When the intermediate number is called, the authentication server may receive the call request, and the acquisition module 240 may acquire a number for initiating a call to the intermediate number (e.g., the second user identification code) from the telephone communication network.

The authentication module 250 is used to verify consistency between the first user identification code and the second user identification code, and an authentication result is returned to the business server.

If the authentication result of the authentication module 250 shows consistency between the first user identification code and the second user identification code, then the authentication for the client-side user is determined to be verified, and the business server may respond to the data interaction request; if the authentication result of the authentication module 250 shows inconsistency between the first user identification code and the second user identification code, then the authentication for the client-side user may be determined to have failed. In this case, the business server may the data interaction request and notify the client-side user that the authentication has failed.

According to some embodiments of the present application, the authentication module 250 may record the interaction record of the user during the call process, and determine whether the interaction record meets the preset interaction requirement. If the interaction record meets the preset interaction requirement, and the authentication module 250 finds consistency between the first user identification code and the second user identification code, then the identity authentication of the user is determined to be verified. Otherwise, if a condition is not met, then the identity authentication of the user is determined to have failed. The authentication result is then sent to the business server.

A corresponding intermediate number may be allocated by the authentication server for the first user identification code sent by the business server, and the corresponding intermediate number may be provided to the client of the user by the business server. When the intermediate number receives the call, a second user identification code is used to call the intermediate number is acquired from the telephone communication network, and the authentication result is obtained by verifying the consistency between the first user identification code and the second user identification code. In this way, the closed nature of a telephone communication network, and the open nature of the internet are brought together to increase security and improve performance. Furthermore, the telephone communication network has a higher access threshold in comparison to the internet due to the closure of the telephone communication network, making it difficult to be accessed externally. Therefore, the reliability and the security of identity authentication are improved effectively by applying a high security telephone communication network to identity authentication over the traditional internet, and by changing the identity authentication process from an asynchronous flow to a synchronous flow.

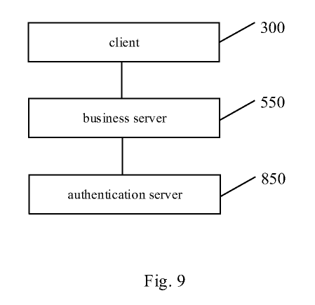

FIG. 9 is a schematic diagram showing an exemplary identity authentication system according to embodiments of the present application.

As shown in FIG. 9, the identity authentication system includes: a business server 550, an authentication server 850 and a client 300.

The business server 550 may be any business server described in the present application.

The authentication server 850 may be any authentication server described in the present application.

The client 300 may be a device for interacting with a web page, an application, a wireless application protocol (WAP) page, etc.

For the identity authentication system of the present application embodiment, when the business server receives the data interaction request of the client, the first user identification code corresponding to the client may be acquired, and the intermediate number corresponding to the first user identification code is acquired from the authentication server and sent to the client for display, allowing the client-side user to initiate a call to the intermediate number over the telephone communication network. The authentication server may acquire a second user identification code used to initiate a call to the intermediate number from the telephone communication network, and the authentication result is obtained by verifying the consistency between the first user identification code and the second user identification code. In this way, the closed nature of a telephone communication network, and the open nature of the internet are brought together to increase security and improve performance. The telephone communication network has a higher access threshold compared to the internet due to the closed nature of the telephone communication network, making it difficult to be accessed externally. Therefore, the reliability and the security of the identity authentication are improved effectively by applying the high security telephone communication network to identity authentication on the traditional internet, and by changing the identity authentication process from an asynchronous flow to a synchronous flow.

Any process or method in the flow diagrams or otherwise described herein may be understood as including modules, sections or portions of executable instructions for one or more steps used to implement specific logic functions or processes. Also, the scope for the preferred embodiments of the present application includes another implementation, which may not follow the illustrated or discussed orders, including function execution by means of fundamentally simultaneous approaches or in reverse orders according to involved functions, which should be understood by those of skill in the art relating to the embodiments in the present application.

The logics and/or steps illustrated in the flow diagrams or described otherwise herein, such as a sequencing list of executable instructions which may be regarded to be used for implementation of logic functions, may be embodied in any computer readable medium for the instruction execution systems, devices or equipment (e.g., computer based systems, systems including processors, or other systems which may retrieve and execute instructions from instruction execution systems, devices or equipment) to use, or for being used by combining these instruction execution systems, devices or equipment. In this specification, “computer readable medium” may be any device comprising, storing, communicating, propagating or transferring programs for the instruction execution systems, devices or equipment to use, or being used by combining these instruction execution systems, devices or equipment. More specific examples of the computer readable medium (not an exhaustive list) include: electrical connection (electronic device) with one or more wirings, portable computer disk box (magnetic device), random access memory (RAM), read only memory (ROM), erasable programmable read only memory (EPROM or flash storage), optical fiber device, and portable compact disk read only memory (CDROM). Further, the computer readable medium may even be a paper or other proper medium on which the program may be printed because, for example, the program may be obtained electronically through performing optical scan for the paper or the other medium, and then performing edition, explanation or, as needed, performing process by other appropriate approaches, followed by storing the program in a computer storage.

It should be understood that various portions in the present application may be implemented by using hardware, software, firmware or a combination thereof. In the embodiments, multiple steps or methods may be implemented in software or firmware stored in a storage and executed by an appropriate instruction execution system. For example, if hardware is used for implementation, the implementation is possible by using any one of the following technologies well known in the art as another embodiment: a discrete logic circuit of logic gates used to implement logic functions for data signals, an application specific integrated circuit with appropriate combinational logic gates, a programmable gate array (PGA), a field programmable gate array (FPGA) etc.

Those of ordinary skill in the art may understand that all or portions of the steps in the methods of the embodiments mentioned above may be implemented by instructing related hardware through a program. The program may be stored in a computer readable storage medium. The program includes one of the steps or a combination thereof of a method embodiment in execution.

Moreover, various functional units in various embodiments of the present application may be integrated in one process module, various units may exist alone physically, or two or more units may be integrated into one module. The integrated module mentioned above may be implemented in a form of hardware, or may be implemented in a form of software functional module. The integrated module may also be stored in one computer readable storage medium if it is implemented in a form of software functional module and is sold or used as an independent product.

The storage medium mentioned above may be a storage, magnetic disk or compact disk etc.

In the description of the specification, reference terms “one embodiment”, “some embodiments”, “example”, “specific example” or “some examples” refer to a combination of specific features, structures, materials or characteristics of the embodiment or example descriptions included in at least one of the embodiments or examples of the present application. In the specification, schematic expressions for the terms mentioned above may not indicate the same embodiments or examples necessarily. Moreover, the described specific features, structures, materials or characteristics may be combined appropriately in any one or more embodiments or examples.

While the embodiments of the present application have been illustrated and described, those of ordinary skill in the art may understand various variations, modifications, replacements and alternations to these embodiments are possible without departing from the principles and purposes of the present application, and the scope of the present application is defined in claims and the equivalents thereof.

What is claimed is:

1. An identity authentication method, comprising:
acquiring a first user identification code corresponding to a client responsive to a data interaction request of the client;
sending the first user identification code to an authentication server;
acquiring an intermediate number corresponding to the first user identification code from the authentication server;
sending the intermediate number to the client for initiating a call request to the intermediate number using a telephone communication network;
receiving an authentication result from the authentication server, wherein the authentication result is based on the call request; and
processing the data interaction request according to the authentication result.

2. The identity authentication method according to claim 1, further comprising identifying a risk level corresponding to the data interaction request,
wherein the first user identification code is acquired when the risk level corresponding to the data interaction request is higher than a preset level.

3. The identity authentication method according to claim 1, wherein the acquiring the first user identification code comprises extracting the first user identification code from a user database.

4. The identity authentication method according to claim 1, wherein the acquiring the first user identification code comprises sending a user identification code input request to the client for inputting the first user identification code.

5. The identity authentication method according to claim 1, further comprising:
receiving an interaction record sent by the authentication server; and
performing identity authentication for the client according to the interaction record of the authentication result.

6. An identity authentication method, comprising:
receiving a first user identification code sent by a business server;
allocating an intermediate number for the first user identification code;
sending the intermediate number to the business server, wherein the intermediate number is provided to a client device of a user by the business server;
acquiring a second user identification code;
initiating a call using to the intermediate number over a telephone communication network;
authorizing the user, based on the first user identification code and the second user identification code, to generate an authentication result; and
sending the authentication result to the business server.

7. The identity authentication method according to claim 6, wherein the allocating the intermediate number for the first user identification code comprises randomly selecting a temporary number from a preset number pool, and using the temporary number as the intermediate number for the first user identification code.

8. The identity authentication method according to claim 6, wherein the allocating the intermediate number for the first user identification code comprises using a preset number as the intermediate number corresponding to the first user identification code.

9. A server, comprising:
a first acquisition module for acquiring a first user identification code corresponding to a client when a data interaction request is received from the client;
a first sending module for sending the first user identification code to an authentication server;
a second acquisition module for acquiring an intermediate number corresponding to the first user identification code from the authentication server;
a second sending module for sending the intermediate number to the client for a client-side user to initiate a call request to the intermediate number using a telephone communication network;
a first receiving module, for receiving an authentication result of the identity authentication from the authentication server according to the call request; and
a process module for processing the data interaction request according to the authentication result.

10. The business server according to claim 9, further comprising an identification module for identifying a risk level corresponding to the data interaction request,
wherein the first acquisition module is used to acquire the first user identification code of the client-side user when the risk level corresponding to the data interaction request is higher than a preset level.

11. The business server according to claim 9, wherein the first acquisition module is for extracting the first user identification code of the client-side user from a user database.

12. The business server according to claim 9, wherein the first acquisition module is for
sending a user identification code input request to the client for the client-side user to input the first user identification code.

13. The business server according to claim 9, further comprising:
a second receiving module, used for receiving an interaction record sent by the authentication server during a call process; and
an authentication module, used for performing identity authentication for the client according to the interaction record.

14. An authentication server, comprising:
a receiving module for receiving a first user identification code sent by a business server;
an allocation module for allocating an intermediate number corresponding to the first user identification code;
a returning module for returning the intermediate number to the business server to provide the intermediate number to a client;
an acquisition module for acquiring a second user identification code, wherein a call is initiated to the intermediate number using a telephone communication network and the second user identification code; and
an authentication module for verifying consistency between the first user identification code and the second user identification code to generate an authentication result, and for sending the authentication result to the business server.

15. The authentication server according to claim 14, wherein the allocation module is for randomly selecting a temporary number from a preset number pool, and using the temporary number as the intermediate number corresponding to the first user identification code.

16. The authentication server according to claim 14, wherein the allocation module is used for
setting a preset number as the intermediate number corresponding to the first user identification code.

17. An identity authentication system, comprising:
a first server, comprising:
a first memory used to store user identification codes; and
a first processor communicatively coupled to the first memory that acquires a first user identification code corresponding to a client when a data interaction request is received from the client, sends the first user identification code to a second server, acquires an intermediate number corresponding to the first user identification code from the second server, sends the intermediate number to the client for a client-side user to initiate a call request to the intermediate number using a telephone communication network, receives an authentication result of the identity authentication from the second server according to the call request, and processes the data interaction request according to the authentication result; and
the second server, comprising:
a second memory used to store user identification codes; and
a second processor communicatively coupled to the second memory that receives the first user identification code sent by the first server, allocates an intermediate number corresponding to the first user identification code, returns the intermediate number to the first server to provide the intermediate number to a client, acquires the second user identification code, wherein a call is initiated to the intermediate number using a telephone communication network and the second user identification code, verifies consistency between the first user identification code and the second user identification code to generate an authentication result, and sends the authentication result to the first server.

18. The identity authentication system according to claim 17, wherein the first processor extracts the first user identification code of the user from a user database.

19. The identity authentication system according to claim 17, wherein the second server processor randomly selects a temporary number from a preset number pool, and uses the temporary number as the intermediate number corresponding to the first user identification code.

20. The identity authentication system according to claim 17, wherein the second server uses a preset number as the intermediate number corresponding to the first user identification code.
